(19) United States
(12) Patent Application Publication
(10) Pub. No.: US 2014/0338749 A1
(43) Pub. Date: Nov. 20, 2014

(54) PHOTOCATALYTIC MATERIAL AND GLAZING OR PHOTOVOLTAIC CELL COMPRISING SAID MATERIAL

(71) Applicant: Rosiana Aguiar, Paris (FR)

(72) Inventor: Rosiana Aguiar, Paris (FR)

(73) Assignee: SAINT-GOBAIN GLASS FRANCE, Courbevoie (FR)

(21) Appl. No.: 14/344,558

(22) PCT Filed: Sep. 12, 2012
(86) PCT No.: PCT/FR2012/052035

§ 371 Date: Mar. 12, 2014

(30) Foreign Application Priority Data
Sep. 13, 2011 (FR) 1158120

(51) Int. Cl. H01G 9/20; C03C 17/34

(52) U.S. Cl. CPC H01G 9/2031; C03C 17/3417; C03C 2217/71
USPC 136/261; 65/60.2; 427/74

(57) ABSTRACT

A material includes a glass or glass-ceramic sheet provided on at least one portion of one of its faces with a photocatalytic coating based on titanium oxide deposited on a silica-based sublayer deposited by combustion chemical vapor deposition, the roughness Ra of which is between 4 and 30 nm, limits included.

The invention relates to the field of materials comprising a glass substrate provided with a photocatalytic coating.

Photocatalytic coatings, especially those based on titanium dioxide, are known for conferring self-cleaning and anti-soiling properties on the substrates that are provided therewith. Two properties are at the origin of these advantageous features. Titanium oxide is first of all photocatalytic, that is to say that it is capable, under suitable radiation, generally ultraviolet radiation, of catalyzing the degradation reactions of organic compounds. This photocatalytic activity is initiated within the layer by the creation of an electron-hole pair. Furthermore, titanium dioxide has an extremely pronounced hydrophilicity when it is irradiated by this same type of radiation. This high hydrophilicity, sometimes described as “super-hydrophilicity”, allows mineral soiling to be removed under water runoff, for example rainwater runoff. Such materials, in particular glazing units, are described, for example, in application EP-A-0 850 204.

Titanium dioxide has a high refractive index, which leads to high light reflection factors for substrates provided with photocatalytic coatings. This constitutes a drawback in the field of glazing units for buildings, and even more in the field of photovoltaic cells, for which it is necessary to maximize the transmission to the photovoltaic material, and therefore to minimize all absorption and reflection of solar radiation. There is, however, a need to provide the photovoltaic cells with a photocatalytic coating, since the deposition of soiling is capable of reducing the efficiency of the photovoltaic cells by around 6% per month. This number is obviously dependent on the geographical location of the cells.

In order to reduce the light reflection factor, it is possible to reduce the thickness of the photocatalytic coatings, but this is done to the detriment of their photocatalytic activity.

The objective of the invention is to propose photocatalytic materials based on titanium oxide combining both a high photocatalytic activity and low light reflection factors.

For this purpose, one subject of the invention is a material comprising a glass or glass-ceramic sheet provided on at least one portion of one of its faces with a photocatalytic coating based on titanium oxide deposited on a silica-based sublayer that is deposited by combustion chemical vapor deposition, the roughness Ra of which is between 4 and 30 nm, limits included.

Another subject of the invention is a process for obtaining a material according to the invention. This preferred process comprises the following steps:
depositing a silica-based sublayer on a glass or glass-ceramic sheet using a combustion chemical vapor deposition process, then
depositing a photocatalytic coating based on titanium oxide on said silica-based sublayer, said sublayer being subjected to a temperature of at least 300° C. prior to the deposition of said photocatalytic coating and/or during the deposition of said photocatalytic coating.

It has turned out that the use of particularly rough silica-based sublayers obtained by combustion chemical vapor deposition was able to significantly reduce the light reflection factor of the material.

The roughness Ra corresponds to the arithmetic mean deviation of the roughness profile. This value is measured by atomic force microscopy on a square with sides of 1000 nm, in non-contact mode and using a silicon tip, the radius of curvature of which is 15 nm.

The substrate is a glass or glass-ceramic sheet. The sheet may be flat or curved, and have any type of dimensions, especially greater than 1 meter. The glass is preferably of soda-lime-silica type, but other types of glasses, such as borosilicate glasses or aluminosilicates, may also be used. The glass may be clear or extra-clear, or else tinted, for example tinted blue, green, amber, bronze or grey. The thickness of the glass sheet is typically between 0.5 and 19 mm, in particular between 2 and 12 mm, or even between 4 and 8 mm. In the field of photovoltaic cells, the glass is preferably extra-clear; it preferably comprises a total weight content of iron oxide of at most 150 ppm, or 100 ppm and even 90 ppm, or a redox of at most 0.2, especially 0.1 and even a zero redox. The term “redox” is understood to mean the ratio between the weight content of ferrous iron oxide (expressed in the form FeO) and the total weight content of iron oxide (expressed in the form Fe₂O₃).

The photocatalytic coating based on titanium oxide preferably consists of titanium oxide, especially crystallized in anatase form, which is the most active form. A mixture of anatase and rutile phases is also possible. The titanium oxide may be pure or doped, for example doped with transition metals (especially W, Mo, V, Nb), lanthanide ions or noble metals (such as, for example, platinum or palladium), or else with nitrogen, carbon or fluorine atoms. These various doping forms make it possible either to increase the photocatalytic activity of the material, or to shift the band gap of the titanium oxide to wavelengths close to the visible range or within this range.

The photocatalytic coating is normally the last layer of the stack deposited on the substrate, in other words the layer of the stack furthest from the substrate. This is because it is important for the photocatalytic coating to be in contact with the atmosphere and its pollutants. It is however possible to deposit a very thin layer, generally discontinuous or porous, on the photocatalytic layer. This may, for example, be a layer based on noble metals intended to increase the photocatalytic activity of the material.

The thickness of the photocatalytic coating is preferably between 1 and 20 nanometers, in particular between 2 and 15 nm, or even between 3 and 10 nm, limits included. A large thickness makes it possible to increase the photocatalytic activity of the layer but at the expense of the light reflection. In the whole of the present text, the thicknesses are physical thicknesses.

The silica-based sublayer is preferably made of silica, that is to say consists of silica. It is understood that the silica may be pure or doped, or may not be stoichiometric. The silica may, for example, be doped with boron or phosphorus atoms, or else with carbon or nitrogen atoms.

The silica-based sublayer is preferably deposited in contact with the substrate.

The roughness Ra of the silica-based sublayer is advantageously between 5 and 25 nm, limits included, in particular between 8 and 20 nm or between 10 and 15 nm.

The thickness of the silica-based sublayer is preferably between 10 and 100 nm, limits included, in particular between 10 and 80 nm, or between 15 and 50 nm, and even between 20 and 30 nm. A sufficient thickness enables the sublayer to act as a barrier layer to the migration of alkali metal ions originating from the substrate when the latter contains them (for example if it is a soda-lime-silica glass substrate).

The silica-based sublayer is preferably non-porous, in particular in the sense that no pores are observed by microscopy techniques, such as transmission electron microscopy (TEM). The purpose of subjecting the sublayer to a temperature of at least 300° C. used in the preferred process according to the invention, prior to the deposition and/or during the deposition of the photocatalytic coating is to densify the sublayer.

The material according to the invention preferably has a light transmission factor (within the meaning of the ISO 9050 :2003 standard) of at least 85%, or 88% and even 90% or 91% and/or a light reflection factor (within the meaning of the ISO 9050:2003 standard) of at most 10%, in particular 9% or 8%.

The silica-based sublayer is deposited by combustion chemical vapor deposition. This technique, also known under its acronym CCVD (for combustion CVD), consists in reacting or decomposing at least one precursor of the layer to be deposited (generally an organometallic compound, a metal salt or a halide) within a flame placed in the vicinity of the substrate. The process is normally carried out at atmospheric pressure. The precursor, pure or dissolved in a solvent, decomposes under the effect of the heat and is deposited on the substrate. In a continuous process, the flame typically results from a fixed linear burner extending over the entire width of the substrate, the latter running past the burner. The flame results from the reaction between a fuel (typically propane or butane and in this case the solvent is preferably non-combustible, or else the solvent when it is combustible) and an oxidizer (typically air, oxygen-enriched air or oxygen). The silica precursor is typically an organometallic compound of silicon or an organic salt, such as a silane or a siloxane. Hexamethyldisiloxane (HDMSO) and tetraethylorthosilicate (TEOS) are particularly suitable. The silica precursor may also be a halogenated compound, such as for example SiCl₄. The solvent may be combustible, such as an organic solvent, or preferably non-combustible, typically water.

The substrate may be heated prior to the deposition and/or during the deposition, for example at a temperature between 300° C. and 600° C., in particular between 400° C. and 550° C.

It has turned out that such a process makes it possible, under certain conditions which are set out below, to obtain silica layers that are particularly rough, in particular in comparison with other techniques, such as CVD. Without wishing to be tied to any one scientific theory, it would appear that under certain conditions which are specified in the remainder of the text, the decomposition of the precursor within the flame forms nanoparticles of silica which are then deposited on the layer forming clusters, therefore conferring a significant roughness. The subsequent heating of the sublayer makes it possible to densify it and to attach it to the substrate, but astonishingly without significantly reducing its roughness. A high roughness of the silica-based layer can be obtained by increasing the size of the nanoparticles. In order to do this, it is possible to carry out at least one of the following adjustments: increase the residence time of the particles in the flame, reduce the flow rate of fuel and oxidizer, increase the distance between the burner and the substrate, increase the concentration of precursor in the solvent, increase the flow rate of precursor. The specific values to be given to these parameters are of course highly dependent on the deposition device used, so that they cannot be specified here in absolute terms. The exemplary embodiments explained in detail in the remainder of the text specify certain values.

The silica-based sublayer is preferably subjected to a temperature of at least 400° C., or even 500° C. prior to the deposition of said photocatalytic coating and/or during the deposition of said photocatalytic coating.

The deposition of the photocatalytic coating is preferably carried out by chemical vapor deposition. It may also be carried out by other deposition techniques, such as for example combustion chemical vapor deposition.

Chemical vapor deposition, generally denoted under its acronym CVD, is a pyrolysis process using gaseous precursors that decompose under the effect of the heat of the substrate. In the case of titanium oxide, the precursors may be, by way of example, titanium tetrachloride, titanium tetraisopropoxide or titanium tetraorthobutoxide.

Preferably, the deposition of the sublayer and the deposition of the photocatalytic coating are carried out successively, on the line for producing glass by the float process. In this continuous process, a ribbon of glass is obtained by pouring the glass at around 1100° C. onto a bath of molten tin within a chamber referred to as a float chamber. On exiting this chamber, the temperature of the glass is of the order of 500° C. to 600° C. and the ribbon of glass then passes into a chamber referred to as a lehr, where the glass is cooled in a controlled manner in order to eliminate all residual mechanical stresses within it. Preferably, the deposition of the sublayer and the deposition of the photocatalytic coating are carried out successively, between the output of the float chamber and the inlet of the lehr. The burner used for the combustion chemical vapor deposition and the chemical vapor deposition nozzle are therefore preferably installed between the outlet of the float chamber and the inlet of the lehr. Typically, the temperature of the glass when the silica-based sublayer is being deposited is between 480° C. and 600° C., in particular between 500° C. and 550° C., and the temperature of the glass when the photocatalytic coating is being deposited is between 430° C. and 550° C., in particular between 450° C. and 500° C. In this way, the silica-based sublayer is naturally subjected to a temperature of at least 300° C. prior to the deposition and during the deposition of the photocatalytic coating, and therefore densified and attached to the substrate, without having to provide additional energy, for example by placing the substrate in a furnace.

Another subject of the invention is glazing or a photovoltaic cell comprising at least one material according to the invention.

The glazing may be single glazing or multiple glazing (especially double or triple glazing), in the sense that it may comprise several glass sheets providing a gas-filled space. The glazing may also be laminated and/or tempered and/or hardened and/or curved.

The other face of the material according to the invention, or where appropriate a face of another substrate of multiple glazing, may be coated with another functional layer or with a stack of functional layers. It may especially be another photocatalytic layer. It may also be layers or stacks having a thermal function, in particular solar-protection or low-emissivity layers or stacks, for example stacks comprising a silver layer protected by dielectric layers. It may also be a mirror layer, especially based on silver. It may finally be a lacquer or an enamel intended to opacify the glazing in order to make a wall cladding panel therefrom, known as spandrel glass. The spandrel glass is positioned on the wall at the sides of non-opacified glazing and makes it possible to obtain walls that are entirely glazed and homogenous from an esthetic point of view.

In the photovoltaic cell according to the invention, the material according to the invention is preferably the substrate of the front face of the cell, that is to say that which is the first passed through by the solar radiation. The photocatalytic coating is then positioned towards the outside, so that the self-cleaning effect can usefully be demonstrated.

For applications as photovoltaic cells, and in order to maximize the energy efficiency of the cell, several improvements may be made, cumulatively or alternately:
The glass sheet may advantageously be coated, on the face opposite the face provided with the coating according to the invention, with at least one thin transparent and electrically conductive layer, for example based on SnO₂:F, SnO₂:Sb, ZnO:Al or ZnO:Ga. These layers may be deposited on the substrate by various deposition processes, such as chemical vapor deposition (CVD) or deposition by sputtering, especially when enhanced by a magnetic field (magnetron sputtering process). In the CVD process, halide or organometallic precursors are vaporized and transported by a carrier gas to the surface of the hot glass, where they decompose under the effect of the heat to form the thin layer. The advantage of the CVD process is that it is possible to use it within the process for forming the glass sheet, especially when it is a float process. It is thus possible to deposit the layer at the moment when the glass sheet is on the tin bath, at the outlet of the tin bath, or else in the lehr, that is to say at the moment when the glass sheet is annealed in order to eliminate the mechanical stresses.
The glass sheet coated with a transparent and electrically conductive layer may be, in turn, coated with a semiconductor based on amorphous or polycrystalline silicon, on chalcopyrites (especially of the CIS—CuInSe₂ or CIGS—CuInGaSe₂ type) or on CdTe in order to form a photovoltaic cell. In this case, another advantage of the CVD process lies in obtaining a greater roughness, which generates a light-trapping phenomenon, which increases the amount of photons absorbed by the semiconductor. The presence according to the invention of a rough silica-based sublayer also helps to amplify this light-trapping phenomenon.
The surface of the glass sheet may be textured, for example have patterns (especially pyramid-shaped patterns), as described in applications WO 03/046617, WO 2006/134300, WO 2006/134301 or else WO 2007/015017. These texturings are in general obtained using a rolling process for forming the glass.

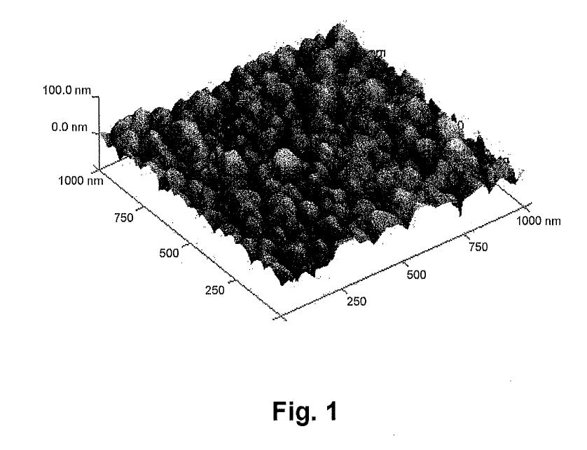

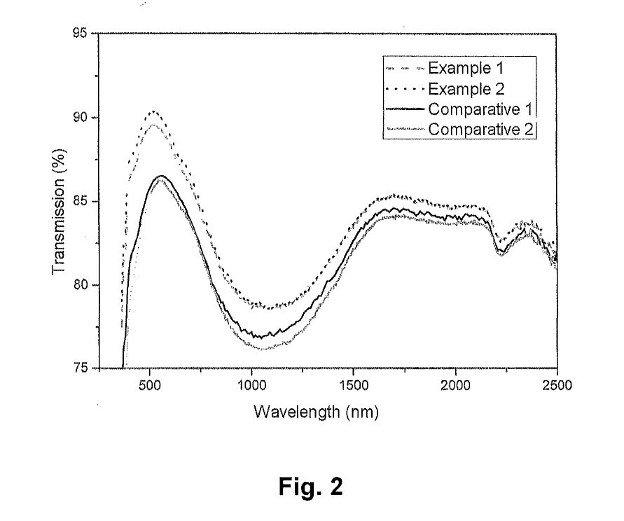

The invention will be better understood in light of the following non-limiting examples, illustrated by FIGS. 1 and 2.

### FIRST SERIES OF EXAMPLES

### Example 1

A silica sublayer having a thickness of 30 nm is deposited on a glass substrate by combustion chemical vapor deposition (CCVD). In order to do this, a flame obtained by combustion of propane (flow rate of 6 l/min) with air (flow rate of 150 /min) is placed 15 mm away from the surface to be coated. The substrate passes at a speed of 2 m/min beneath the flame, while a HDMSO (hexamethyldisiloxane) precursor is introduced into the flame with a flow rate of 0.5 /min.

After deposition of the sublayer, a titanium oxide photocatalytic coating having a thickness of around 10 nm is deposited on the sublayer by a CVD technique. In order to do this, the substrate provided with the sublayer is heated to around 530° C., and a precursor of titanium oxide, titanium tetraisopropoxide, dissolved in a carrier gas (nitrogen) is brought into contact with the surface of the substrate.

### Example 2

This example is carried out in the same way as example 1, the only difference being that the silica sublayer is thicker (60 nm), owing to a second pass. During the second pass, the flow rate of propane is 10 /min, the flow rate of air is 250 /min and the flow rate of precursor is 1 /min. The distance between the flame and the substrate is 30 mm.

### Comparative Examples

In comparative example 1, the photocatalytic coating is obtained in the same way as in the case of example 1 according to the invention. On the other hand, the sublayer is a layer of silicon oxycarbide deposited by CVD (and not by CCVD), and that is consequently much less rough.

In comparative example 2, the sublayer is a layer of silica deposited by magnetron sputtering, that is also much less rough. The photocatalytic coating is the same as in the case of comparative example 1.

FIG. 1 is an image obtained by atomic force microscopy (AFM) of the surface of example 1 that makes it possible to observe the high roughness imparted by the silica sublayer.

FIG. 2 groups together the transmission spectra of the four examples.

Table 1 below summarizes the results of the tests. It indicates, for each example, the following quantities:
the roughness Ra, expressed in nm,
the photocatalytic activity Kb, expressed in μg.1⁻¹.min⁻¹,
the light reflection factor RR, the light transmission factor TL and the energy transmission factor TE, within the meaning of the ISA 9050:2003 standard,
the “TSQE” transmission factor, corresponding to the convolution integral of the transmission spectrum of the material and of the curve of quantum efficiency of the amorphous silicon. This factor makes it possible to evaluate the transmission of the material in the relevant wavelengths for photovoltaic cells using amorphous silicon.

The roughness Ra is measured using a Nanoscope IIIa atomic force microscope (AFM) on a square having sides of 1000 nm, in non-contact mode and using a silicon tip, the radius of curvature of which is 15 nm.

The photocatalytic activity is evaluated owing to a measurement of the rate of degradation of methylene blue in the presence of ultraviolet radiation. An aqueous solution of methylene blue is placed in contact, in a leaktight cell, with the coated substrate (the latter forming the bottom of the cell). After exposure to ultraviolet radiation for 30 minutes, the concentration of methylene blue is evaluated by a light transmission measurement. The value of photocatalytic activity (denoted by Kb and expressed in μg.1⁻¹.min⁻¹), corresponds to the reduction in the concentration of methylene blue per unit of exposure time.

TABLE 1

| | Ra | Kb | RL | TL | TE | TSQE |
|---|---|---|---|---|---|---|
| Example | (nm) | (μg · l⁻¹ · min⁻¹) | (%) | (%) | (%) | (%) |
| 1 | 10.4 | 41 | 9 | 89 | 84 | 88 |
| 2 | 12.0 | 42 | 8 | 90 | 85 | 89 |
| Comparative 1 | 1.5 | 40 | 12 | 86 | 81 | 85 |
| Comparative 2 | 0.6 | 38 | 12 | 86 | 81 | 84 |

### SECOND SERIES OF EXAMPLES

### Example 3

A silica sublayer having a thickness of 20 nm is deposited on a sheet of clear glass having a thickness of 2 mm by CCVD. In order to do this, six passes under an air-propane flame are made, using a solution of a HDMSO precursor in ethanol. The propane and air flow rates are respectively 8 and 160 /min. The concentration of precursor in the ethanol is 0.1 mol/l, and the rate of introduction of the precursor solution into the flame is 2 μ/min. The distance between the burner and the substrate is 7 mm and the run speed of the substrate is 6 m/h. The substrate is heated at a temperature of 520° C. prior to the deposition.

The photocatalytic coating is similar to that from the preceding examples.

### Comparative Example 3

The deposition conditions for the silica sublayer differ from those of example 3 in that the distance between the substrate and the burner is 5 mm, and the rate of introduction of the precursor solution is 1 μl/min.

TABLE 2

| | Ra | RL | TL |
|---|---|---|---|
| Example | (nm) | (%) | (%) |
| 3 | 21.7 | 8 | 90 |
| Comparative 3 | 1.2 | 11 | 87 |

The deposition conditions for comparative example 3 result in a very low roughness, compared to those of example 3 according to the invention.

These results demonstrate that the use of a rough sublayer obtained by CCVD makes it possible to significantly reduce the reflection of the material, until reflections of the order of that of the bare glass, or even lower, are achieved. This results in light and energy transmissions that are much higher, by 3 to 4 points, without however degrading the photocatalytic activity.

An analysis by Raman spectrometry shows the presence of anatase for all the samples.

The observation of the materials by transmission electron microscopy carried out on the edge shows that the silica layer is dense, and free of any porosity.

1. A material comprising a glass or glass-ceramic sheet provided on at least one portion of one of its faces with a photocatalytic coating based on titanium oxide deposited on a silica-based sublayer deposited by combustion chemical vapor deposition, the roughness Ra of which is between 4 and 30 nm, limits included.

2. The material as claimed in claim 1, such that wherein the photocatalytic coating is made of titanium oxide.

3. The material as claimed in claim 1, wherein the silica-based sublayer is made of silica.

4. The material as claimed in claim 1, wherein the sublayer is deposited in contact with the substrate.

5. The material as claimed in claim 1, wherein the roughness Ra of the sublayer is between 5 and 25 nm, limits included.

6. The material as claimed in claim 1, wherein the thickness of the silica-based sublayer is between 10 and 100 nm limits included.

7. The material as claimed in claim 1, wherein the photocatalytic coating is the last layer of the stack deposited on the glass or glass-ceramic sheet.

8. The material as claimed in claim 1, wherein the thickness of the photocatalytic coating is between 1 and 20 nm, limits included.

9. The material as claimed in claim 1, having a light transmission factor within the meaning of the ISO 9050 :2003 standard of at least 80%, and a light reflection factor within the meaning of the ISO 9050 :2003 standard of at most 10%.

10. A glazing unit or photovoltaic cell comprising at least one material as claimed in claim 1.

11. A process for obtaining a material as claimed in claim 1, comprising the following steps:
depositing a silica-based sublayer on a glass or glass-ceramic sheet using a combustion chemical vapor deposition process, then
depositing a photocatalytic coating based on titanium oxide on said silica-based sublayer, said sublayer being subjected to a temperature of at least 300° C. prior to the deposition of said photocatalytic coating and/or during the deposition of said photocatalytic coating.

12. The process as claimed in claim 11, wherein the deposition of the photocatalytic coating is carried out by chemical vapor deposition.

13. The process as claimed in claim 11, wherein the photocatalytic coating is the last layer of the stack deposited on the glass or glass-ceramic sheet.

14. The process as claimed in claim 11, wherein the deposition of the sublayer and the deposition of the photocatalytic coating are carried out successively, on a line for producing glass by the float process.

15. The process as claimed in claim 14, wherein the deposition of the sublayer and the deposition of the photocatalytic coating are carried out successively, between the outlet of the float chamber and the inlet of the lehr.

16. The material as claimed in claim 2, wherein the titanium oxide is crystallized in anatase form.

17. The material as claimed in claim 6, wherein the thickness of the silica-based sublayer is between 10 and 80 nm, limits included.

18. The material as claimed in claim 9, wherein the light transmission factor within the meaning of the ISO 9050:2003 standard is at least 90%, and the light reflection factor within the meaning of the ISO 9050:2003 standard is at most 9%.
